(19) United States
(12) Patent Application Publication
(10) Pub. No.: US 2017/0087573 A1
(43) Pub. Date: Mar. 30, 2017

(54) A QUICK FASTENING FLEXIBLE DUCT FOR A SPRAY PAINTING DEVICE AND DEVICE INCLUDING THE DUCT

(71) Applicant: HPM ENGINEERING S.R.L., Cassolnovo (Pavia) (IT)

(72) Inventor: Marcela GROHOVA, Barberino di Mugello (Firenze) (IT)

(21) Appl. No.: 15/311,401

(22) PCT Filed: May 20, 2015
(86) PCT No.: PCT/IB2015/053716

§ 371 Date: Nov. 15, 2016

(30) Foreign Application Priority Data
May 23, 2014 (IT) FI2014U000032

(51) Int. Cl. B05B 7/16; B05B 15/06; B05B 7/22

(52) U.S. Cl. CPC B05B 7/162; B05B 7/1693; B05B 7/22; B05B 15/065; B05B 15/061

(57) ABSTRACT

The present invention concerns the field of spray painting systems, and more specifically a painting device that provides for heating of the vector fluid. It is advantageously provided with a quick fastening and unfastening system of the flexible duct that extends between a control unit and a dispensing gun forming an integral part of the duct at its free end.

### FIELD OF THE INVENTION

The present invention concerns the field of spray painting systems, and more specifically a painting device that provides for heating of the vector fluid and it is advantageously provided with a quick fastening and unfastening system of the flexible duct that extends between a control unit and a dispensing gun forming an integral part of the duct at its free end.

### BACKGROUND OF THE INVENTION

Painting devices with heating of the vector fluid are generally known, and more specifically have been proposed in an advantageous solution in which the duct incorporates heating means of the vector fluid in the form of one or more self-regulating heating cables using a resistance, suitable for maintaining a constant temperature when subjected to a constant supply voltage. The cables extend along at least part of the duct starting from the attachment end. Preferably, two or more different self-regulating heating cables are provided, each with set characteristics to obtain a certain temperature, and adapted to be activated selectively, i.e. only one of the two or both, so as to make a selection, with a single duct, between two or more different temperatures according to the specific requirements.

Such a device therefore provides a control unit having suitable switch means that control the electric power supply of the cables, and also responsible for the mechanical support of an end of the duct (the aforementioned attachment end). Moreover, the vector fluid, i.e. compressed air coming from an external production unit, is connected to the control unit, having the form of a box-shaped body or cabinet that is normally hung on a support wall of the painting oven, said vector fluid being placed in pneumatic communication with the duct through the attachment end, inside the same control unit.

The duct represents a component that will rapidly wear, due to the nature of its use. Such wear leads to the need for frequent replacements, which can also be made necessary or suitable to replace a duct with certain performance with another of different characteristics (in particular with regard to the heating performance given by the self-regulating cables).

The replacement operation is, however, laborious and not easy to perform for an unskilled worker, due to the need to remove and independently restore the electrical connections of the cables, and at the same time the mechanical connections, also protecting the pneumatic seal.

### SUMMARY OF THE INVENTION

The object of the present invention is to provide a painting device of the aforementioned type that through a new and particular configuration of the components of the control unit substantially facilitates the operations of removal of the flexible duct and of installation of another duct to replace it, making such operations quick and within the capabilities of an unskilled worker provided with totally standard tools.

According to the invention, this and other objects are achieved with a spray painting device having the characteristics according to the attached claim 1. A duct to be used in the device according to the invention has the features of attached claim 12.

### BRIEF DESCRIPTION OF THE DRAWINGS

The characteristics and advantages of the spray painting duct and device according invention will now become apparent from the following description of an embodiment thereof, given as an example and not for limiting purposes, with reference to the attached drawings, in which:

FIG. 1 is a schematic representation of a control unit or cabinet of a spray painting device according to the invention, with a front door lifted so as to show the inside, in which the electrical and pneumatic connections are also represented;

FIG. 2 shows the cabinet of FIG. 1 in an axonometric view and complete with door in closed or operative configuration; and

FIGS. 3a and 3b again show the cabinet of FIG. 1, in two axonometric view, with the flexible duct mechanically associated and disconnected, respectively, the inside being made visible by the removal of the door, though leaving the electrical switch supported by the door itself visible in the operative position, the electrical and pneumatic connections being omitted for the sake of clarity of illustration.

### DETAILED DESCRIPTION OF THE INVENTION

With reference to said figures, a device according to the invention conventionally comprises a control unit or distribution cabinet 1 comprising a box-shaped body 11, usually parallelepiped, provided with fastening brackets 12 for fastening the same to an outer support like a wall of the operating environment in which the device must be used. The box-shaped body 11 defines a space 2 between a bottom 11 e and side walls 11a-11d that rise from the bottom. The side walls 11a-11d extend up to a free edge intended for engagement with a closing door 3, that closes the space and isolates the internal components in the operative configuration of the device, and is on the other hand removable to gain access to the space itself, in particular for the actions that will be discussed hereafter.

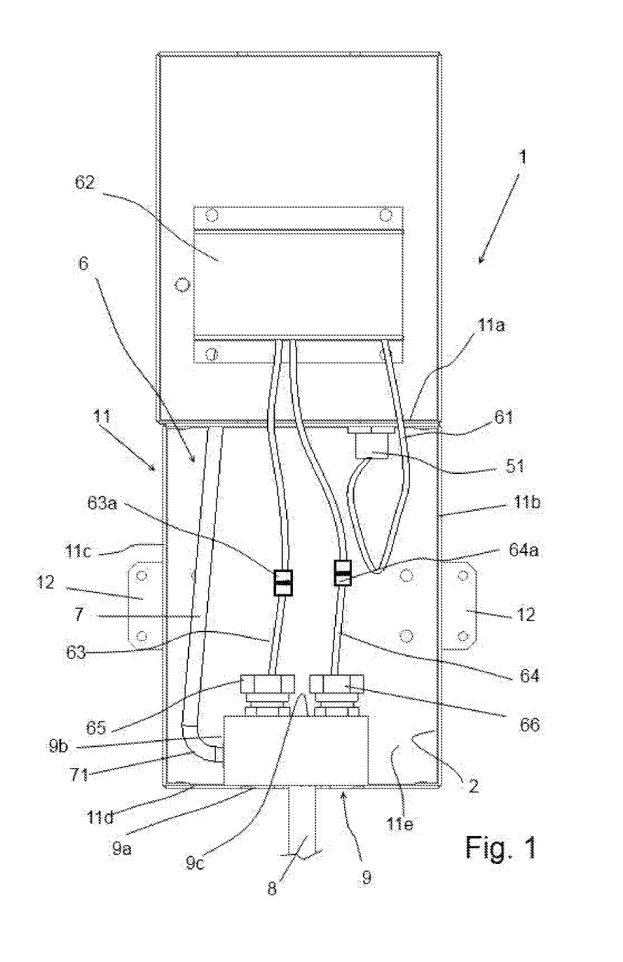

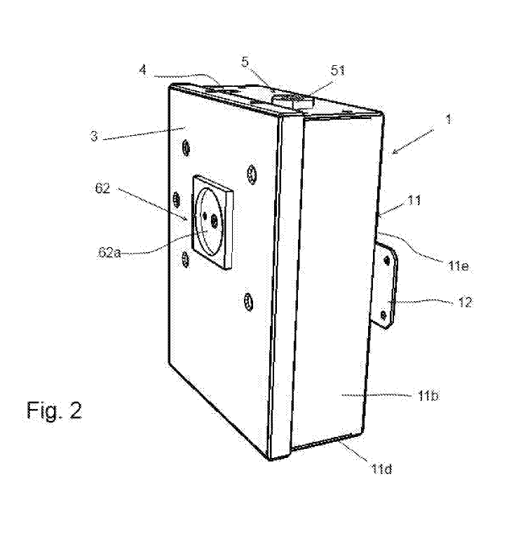

The box-shaped body 11, and more specifically in the example a side wall 11a, comprises inlet passages 4, 5 for a pneumatic supply and an electrical power supply, respectively, the first coming from an external compressor that is not shown, the second from the electrical service network. The electrical inlet passage 5 is engaged by a fitting 51 (a common sealed fairlead) in which an electrical power supply cable 61 is clamped, shown in FIG. 1; analogously, the same figure shows a tube 7 for dispensing compressed air. The side wall 11d opposite the wall 11a is configured, as shall be seen, for the attachment of a flexible painting duct 8, equipped with heating properties of the vector fluid that is drawn from the pneumatic supply 7. The intrinsic characteristics of the duct 8 are per se known and typically are those according to European patent EP2455164 and to be considered incorporated here for reference. The electric cable 61 belongs to a electric power distribution system 6, being connected in the space 2 to a switch 62, of the known type as such, from which two (typically, like in the example) or even more power supply wires 63, 64 branch off, for respective self-regulating heating cables arranged in the duct 8. The switch is indeed used to selectively supply one or other, or both, of the heating cables, to regulate the temperature of the vector fluid between respective preset values determined by the characteristics of the aforementioned heating cables. The switch 62 is mounted on the inner face of the door 3, being adapted to be actuated from the outside (FIG. 2) by manipulation of a wheel 62a.

Both the electric wires 63, 64 and the pneumatic connection tube 7, according to the main aspect of the invention, are connected to a duct coupling block 9. The block 9 is for example an actual parallelepiped body on a first face of which, indicated at 9a, an end of the duct 8 is connected, and internally grooved with appropriate branched channels so as to ensure the pneumatic communication with the tube 7, connected through a quick release releasable connector 71 to a second face 9b adjacent to that of the duct 8. The internal channels also allow for electrical connection of the two inner heating cables with the respective wires 63, 64 (connected to a third face 9c opposite the first face 9a).

Regarding this, fairleads 65, 66 ensure the secure mechanical and electrical connection, as well as the pneumatic seal, between the respective wires and the heating cables the ends of which, as mentioned, reach inside the block. Such fairleads are also of the known type that can be implemented based on the requirements of resistance to the pressure created by the compressed air (up to 15 bar). In the present case the channels provide, for example, a Y-branch between the attachment of the duct 8 and the fairleads 65, 66, together with a further branch that places the pneumatic connector 71 in communication with the aforementioned attachment.

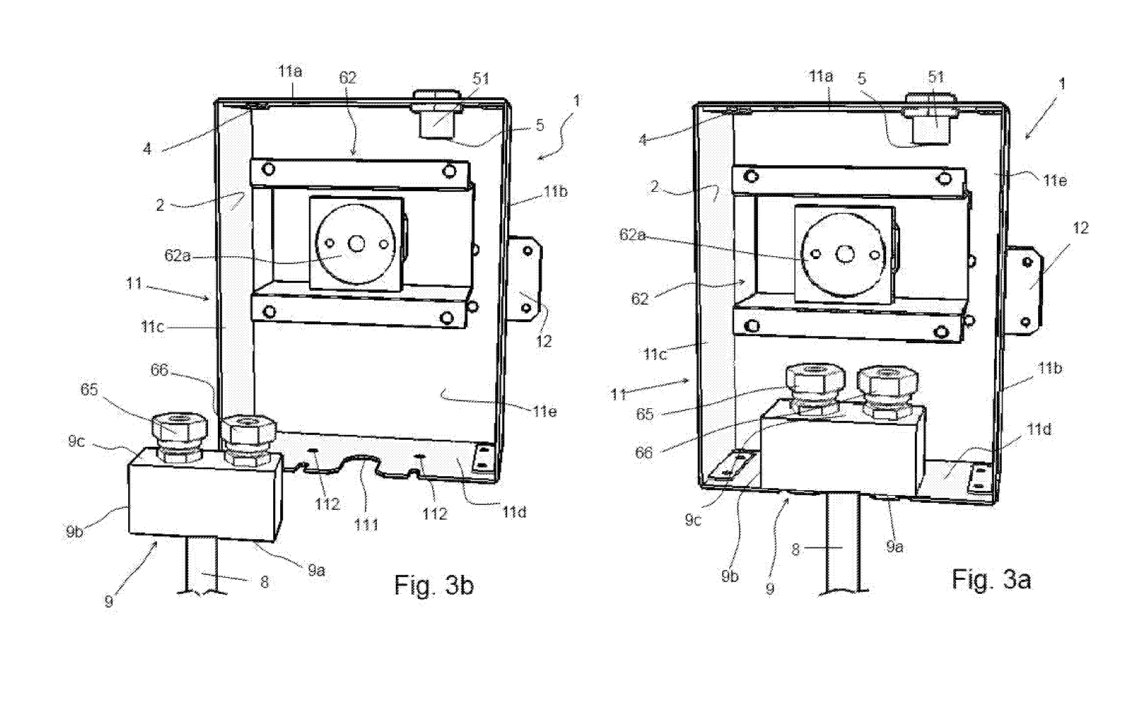

The side wall 11d, which in the normal operative orientation of the control unit will be arranged at a lower position, has, as well visible in FIG. 3b, a notch 111 to allow the duct 8 to pass and be housed in a snug-fit manner. Adjacent to the notch 111 on the same wall there are holes 112 for inserting threaded members, not represented, which engage in seat formed on the block 9 (notably on the first face 9a, also not visible) to secure the block itself in position, clamped with such a first face to the lower wall 11d.

What has just been described refers to the operative configuration of the device (FIGS. 1, 2, 3a). The need to replace the flexible duct, according to the main advantage of the invention, can be satisfied with maximum simplicity, by simply lifting/removing the door 3 (previously secured to the body 11 with obvious fastening means), disconnecting the pneumatic tube 7 from the block 9 and removing the screws that lock it to the lower side wall 11d.

At that point the whole assembly can easily be detached, without any laborious disconnection intervention in sequence of single component. Concerning this, it should be noted that, according to another significant aspect of the invention, the electric wires 63 and 64 are internally equipped with a disconnection through conventional quick release reversible connection systems such as jack connectors 63a, 64a, for which reason simple manual pulling will suffice to free the block 9, associated with two short segments of wire, also from the electrical connection and thus make the duct unit completely detachable (see FIG. 3b, although without the representation of the electrical and pneumatic connections).

It should be understood how the arrangement of a new duct replacing the previous one is equally easy, with interventions, in reverse order, mirroring those just described.

Thanks to the invention a substantial improvement of the functionality of the device is therefore provided, considering that the operation of replacing the duct is very frequent and therefore the fact of having made it quicker and easier, as well as obtaining increased utility per se, implies a substantial reduction in idle times (also due, as things stand, to the need to wait for assistance from trained workers). The compact coupling end determined by the block 9 also makes the exchange more secure and functional with respect to the requirements of transportation, storage and manipulation in general. As well as the simple replacement due to wear of the duct with a new duct of the same type, the system presented here can promote interchangeability of ducts with different characteristics.

The invention is not limited to the embodiment described and illustrated above, but comprises any variant embodiment thereof within the scope of the attached claims.

1. A spray painting device comprising: a flexible painting duct; a box-shaped control unit with at least one side wall, at least one electrical power input, at least one vector fluid supply inlet, and means for distributing said electrical power supply and said vector fluid; the flexible painting duct being provided with at least one heating cable of the vector fluid of the self-regulating type using a resistance arranged in the duct along at least a part thereof, wherein a dispensing gun is arranged at a free end of the duct, said gun being suitable for receiving a supply of painting substance, and wherein mechanical, pneumatic and electrical coupling means to said distribution means are provided at an attachment end of the duct; the device being wherein said coupling means comprise a block fixedly connected to said attachment end of the duct, the block being suitable for being reversibly secured to said wall and comprising, or being associated with: an inner channelling system suitable for placing the inside of said duct and said distribution means in communication; a quick-release reversible pneumatic connection with the distribution means of the vector fluid; and at least one quick-release reversible connection with the electric power distribution means.

2. The device according to claim 1, wherein said block comprises a body with a first face to which an end of the duct is connected, said inner channelling system being adapted for placing the attachment of the duct on the first face in communication with a pneumatic connector provided on a second face adjacent to said first face, and with one or more electrical fairleads arranged on a third face opposite said first face.

3. The device according to claim 2, wherein said at least one reversible connection provides a quick-release electrical connector between a portion of wire extending from the block through a relative fairlead, and a portion of wire of said distribution means of the electric power supply of the device.

4. The device according to claim 3, wherein said at least one quick-release electrical connector is a jack connector.

5. The device according to claim 2, comprising two fairleads for respective heating cables, said inner channelling system comprising at least one Y-branch between the attachment of the duct and said fairleads, together with a further branch that places the pneumatic connector in communication with the aforementioned attachment.

6. The device according to claim 2, wherein said first face is suitable for being arranged in abutment on an inner face of said wall, the latter having an aperture suitable for allowing the passage and the housing in a snug-fit manner of the duct, wherein mechanical fastening means with said wall are provided on said first face.

7. The device according to claim 6, wherein said mechanical fastening means comprises threaded members.

8. The device according to claim 1, wherein said block is parallelepiped.

9. The device according to claim 1, comprising, in addition to the box-shaped control unit with the at least one side wall and the at least one electrical power input, the at least one vector fluid supply inlet, and the distribution means of said electrical power supply and of said vector fluid, quick fastening reversible pneumatic connection means suitable for the coupling between the distribution means of the vector fluid and the pneumatic connection means of the block, at least one quick fastening reversible connection suitable for the electrical coupling between the distribution means of the electrical power supply and the at least one reversible connection of said block, a breaking formed on said wall, suitable for making the duct pass and housing it in a snug-fit manner, and mechanical fastening means with said block formed on said wall.

10. The device according to claim 9, wherein said wall is a lower wall of said box-shaped body.

11. The device according to claim 9, wherein said distribution means of the electrical power supply comprise a switch between the at least one electrical power input and the at least one quick fastening reversible electrical connection towards said block, mounted on an inner face of a liftable door of said box-shaped body, the switch being suitable for being actuated from the outside by manipulation of a control wheel.

12. A flexible spray painting duct comprising at least one heating cable of a vector fluid of the self-regulating type using a resistance arranged in the duct along at least a part thereof, a dispensing gun arranged at a free end of the duct, said gun being suitable for receiving a supply of painting substance, and mechanical, pneumatic and electrical coupling means to relative distribution means of a vector fluid and of electric power provided at an attachment end of the duct; the device wherein said coupling means comprises a block fixedly connected to said attachment end of the duct, the block being suitable for being reversibly secured to a wall of a box-shaped control unit of a painting device and comprising, or being associated with: an inner channelling system suitable for placing the inside of said duct and said distribution means in communication; a quick-release reversible pneumatic connection with the distribution means of the vector fluid; and at least one quick-release reversible connection with the electric power distribution means.

13. The duct according to claim 12, wherein said block comprises a body with a first face to which an end of the duct is connected, said inner channelling system being adapted for placing the attachment of the duct on the first face in communication with a pneumatic connector provided on a second face adjacent to said first face, and with one or more electrical fairleads arranged on a third face opposite said first face.

14. The duct according to claim 13, wherein said at least one reversible connection foresees a quick-release electrical connector of a portion of wire extending from the block through a relative fairlead.

15. The duct according to claim 14, wherein said at least one quick-release electrical connector is a jack connector.

16. The duct according to claim 12, comprising two fairleads for respective heating cables, said inner channelling system comprising at least one Y-branch between the attachment of the duct and said fairleads, together with a further branch that places the pneumatic connector in communication with the aforementioned attachment.

17. The duct according to claim 12, wherein said first face is suitable for being arranged in abutment on an inner face of said wall, and wherein mechanical fastening means with said wall are provided on said first face.

18. The duct according to claim 17, wherein said mechanical fastening means comprises threaded members.

19. The duct according to claim 12, wherein said block is parallelepiped.
